(19) United States
(12) Patent Application Publication
(10) Pub. No.: US 2024/0303631 A1
(43) Pub. Date: Sep. 12, 2024

(54) ACCOUNT AND PAYMENT PROCESSING PLATFORM

(71) Applicant: Entrust Corporation, Shakopee, MN (US)

(72) Inventors: CHRISTOPHER ALLAN GREENWOOD, Centennial, CO (US); TIMOTHY GERLACH, Castle Rock, CO (US); SENAN WILLIAM KELLY, Eden Prairie, MN (US); RAJESH K. JURIASINGANI, Chaska, MN (US)

(73) Assignee: Entrust Corporation, Shakopee, MN (US)

(21) Appl. No.: 18/599,979

(22) Filed: Mar. 8, 2024

Related U.S. Application Data
(60) Provisional application No. 63/489,070, filed on Mar. 8, 2023.

(51) Int. Cl. G06Q 20/34

(52) U.S. Cl. CPC G06Q 20/3563

(57) ABSTRACT

An account and payment processing platform is provided. The platform exposes standardized APIs to financial institutions and application providers, and manages third-party system integrations. Individual financial institutions or application providers are mapped to corresponding core banking or switch network systems, and the mapping may be reconfigured without requiring redevelopment by those application providers or financial institutions to accommodate a new integration that might otherwise be required.

### CROSS-REFERENCE TO RELATED APPLICATIONS

The present application claims priority from U.S. Provisional Patent Application No. 63/489,070, filed on Mar. 8, 2023, the disclosure of which is hereby incorporated by reference in its entirety.

### BACKGROUND

Financial institutions, such as banks, typically offer their customers a variety of financial services including payment products (e.g., credit cards, debit cards, and the like). Such financial institutions may integrate with one or more credit bureaus, card management systems, card activation systems (switches), and payment networks (e.g., Visa, MasterCard, and the like).

Customers of such financial institutions desire increased flexibility and methods of management, control, and payment. As such, financial institutions often work with application providers to incorporate account features into a web application or mobile application affiliated with the financial institution. Both the financial institutions, and the application providers with whom they are integrated, are typically required to develop interfaces, or integrations, with a wide variety of third-party services to achieve a seamless customer experience. That is, a financial institution application may require integration with third party card management systems, card activation systems, external EMV systems, payment networks, and bureaus, and also may require supporting services such as security, identity, and authentication (including multifactor authentication) services.

This variety of third-party integrations that are required for even a single financial institution makes things particularly complex for application providers who wish to offer applications to a variety of financial institutions that work with different card management systems, card activation systems, bureaus, identity providers, and the like. Furthermore, as financial institutions change card management systems with which they are affiliated, application providers may be required to reengineer their interfaces or integrations with those systems, due to differences in communication standards. This results in a highly fragmented and inefficient development environments for both financial institutions and financial application providers.

### SUMMARY

In general, the present application includes to a platform that centralizes account and payment processing. In some instances, the platform may be implemented in a cloud computing environment, and may expose standardized APIs to financial institutions and application providers. The platform may further manage third-party system integrations. In some examples, individual financial institutions or application providers are mapped to corresponding core banking or switch network systems. These mapping may be reconfigured without requiring redevelopment by those application providers or financial institutions to accommodate a new integration.

In a first aspect, system for integrating digital financial services is disclosed. The system comprises an application providing a financial service to a user; a plurality of card management systems; and a platform; wherein the platform is communicatively coupled to the application; wherein the platform is communicatively coupled to each card management system of the plurality of card management systems; wherein the platform is configured to access a database storing mapping data, the mapping data including a mapping between the application and a linked card management system of the plurality of card management systems; and wherein the platform includes a processor and memory, the memory storing instructions that, when executed by the processor, cause the platform to: expose an application programming interface (API); receive, via the API, a request from the application; and based on the mapping between the application and the linked card management system, provide data associated with the request to the linked card management system.

In a second aspect, a computing system is disclosed. The computing system includes a processor and memory storing instructions that, when executed by the processor, provide a cloud platform for facilitating digital financial services, the cloud platform comprising: an interface communicatively connecting the cloud platform to an application associated with a tenant of the cloud platform, the application providing a financial service to a user; a plurality of integrations coupling the cloud platform to each of a plurality of card management systems; a database storing mapping data, the mapping data including a mapping between the tenant and a linked card management system, the linked card management system being from among the plurality of card management systems; wherein the cloud platform is configured to: expose a standardized application programming interface (API) to the application; receive, via the standardized API, a request for execution by a card management system; and based on the mapping between the application and the linked card management system, provide data associated with the request to the linked card management system.

In a third aspect, a method for integrating digital financial services is disclosed. The method comprises receiving, at an application programming interface (API) exposed by a platform, a request for a digital financial service from an application; identify, using mapping data from a database of mapping data, a card management system linked to a tenant of the application, the identified card management system belonging to a plurality of card management systems coupled with the platform; based on the identified card management system, determining a transformation for converting data to be received by the identified card management system; by applying the transformation, converting data associated with the request to data formatted to be received by the identified card management system; and providing the converted data to the identified card management system.

### BRIEF DESCRIPTION OF THE DRAWINGS

FIG. 1 illustrates an example network in which aspects of the present disclosure may be implemented.

FIG. 2 illustrates a schematic block diagram of example aspects of a platform.

FIG. 3 illustrates a block diagram of aspects of a network environment.

FIG. 4 illustrates a block diagram of aspects of a network environment.

FIG. 5A illustrates example mapping data.

FIG. 5B illustrates example mapping data.

FIG. 6 is a flow diagram of an example method that may be performed by a platform.

FIG. 7 is a flow diagram of an example method that may be performed by a platform.

FIG. 8 is a block diagram of an example computing system.

FIG. 9 illustrates a schematic block diagram of communications between systems and other components.

FIG. 10 illustrates a schematic block diagram of communications between a message coordinator and other components.

FIG. 11 illustrates a schematic block diagram of communications between a messaging transformer and other components.

FIG. 12 illustrates a schematic block diagram of communications between application programming interfaces and other components.

FIG. 13 illustrates a schematic block diagram of communications between a transformation service and other components.

FIG. 14A illustrates a diagram of example communications between components.

FIG. 14B illustrates a diagram of example communications between components.

### DETAILED DESCRIPTION

As briefly described above, embodiments of the present invention relate to a platform for integrating account and payment processing systems. The platform exposes standardized APIs to financial institutions and application providers, and manages third-party system integrations. The platform also provides a set of services required for seamlessly enabling typical end user operations, such as integrations with payment card networks, incorporation or facilitation of issuance of a corresponding digital payment card, as well as account management, authentication, identity management, and other services. Individual financial institutions or application providers are mapped to corresponding core banking or switch network systems, and the mapping may be reconfigured without redevelopment to accommodate a new integration that might otherwise be required for interaction by the application provider or financial institution. As a result, among other potential advantages, the integration services described herein may rapidly increase the speed with which external systems are onboarded to the platform and may decrease the software development time and required expertise to develop applications that are correctly linked to backend financial services.

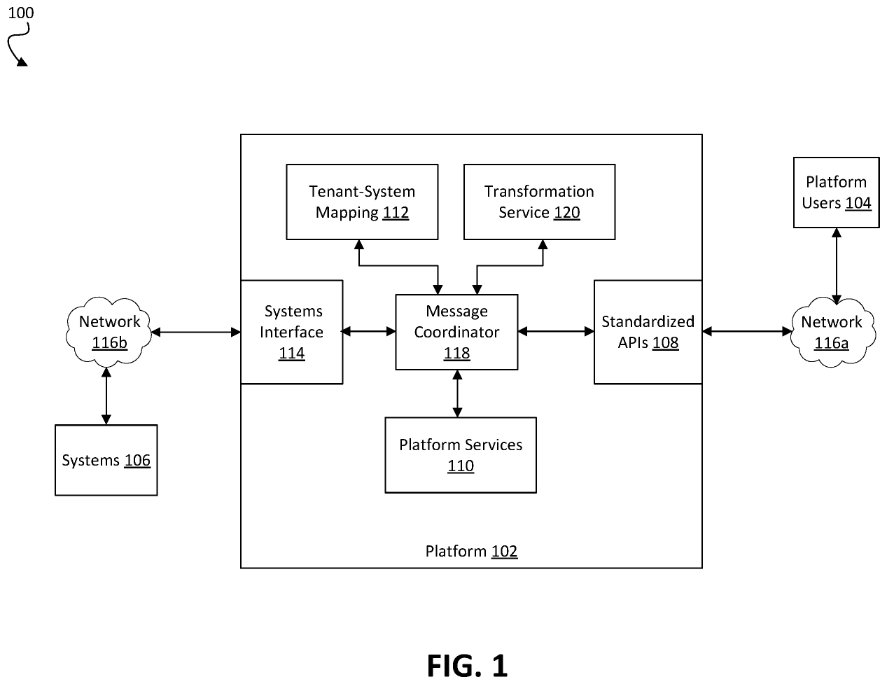

FIG. 1 illustrates an example network environment 100 in which aspects of the present disclosure may be implemented. The example network environment 100 includes a platform 102, platform users 104, systems 106, and networks 116a-b.

The platform 102 may provide services to the platform users 104. In some embodiments, the platform 102 may provide software and hardware services to the platform users 104. In some examples, the services may relate to performing digital operations for financial institutions. The platform 102 may also couple the platform users 104 with the systems 106. For example, as described more herein, the platform 102 may provide a set of APIs that enable the platform users 104 to interact with the systems 106. To facilitate this interaction, the platform 102 may handle the routing, data formatting, and other technical requirements for communicating with the systems 106. The platform 102 may include a plurality of components, each of which may be a combination of software and hardware. For instance, in the example shown, the platform 102 includes standardized APIs 108, platform services 110, tenant-system mapping 112, a systems interface 114, a message coordinator 118, and a transformation service 120. In some embodiments, the platform 102 may include more or fewer components than described herein. Furthermore, the structure and functions of the components of the platform 102 may vary depending on the embodiment.

In some embodiments, the platform 102 is hosted on a cloud computing infrastructure that is accessible via the internet. In some embodiments, the platform 102 may be implemented on physical computing systems of the platform provider, or within a virtualized environment across one or a combination of clouds, including, for example, a combination of public or private clouds. In some embodiments, the platform 102 may be implemented using a hybrid cloud platform. In accordance with the present disclosure, the platform 102 may also be referred to as a “cloud platform” where implemented, in whole or in part, via a cloud hosting arrangement.

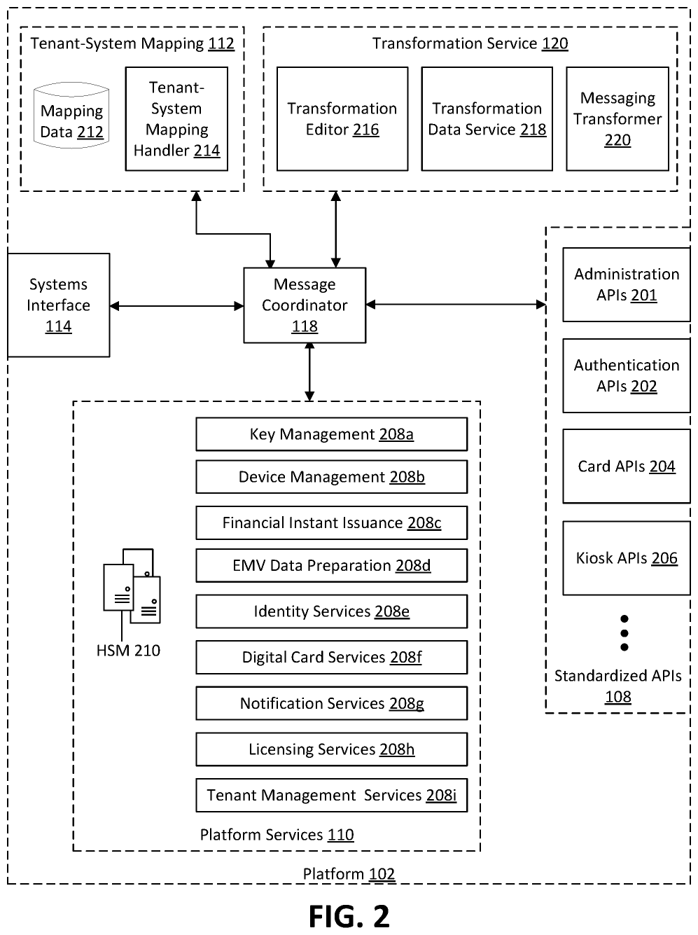

The standardized APIs 108 may be exposed to the platform users 104 and may define the services exposed by the platform 102, as well as the details required to use these services, including any required parameters and expected return values. In some embodiments, the standardized APIs 108 is a REST API gateway. In other examples, however, one or more of APIs of the standardized APIs 108 may not be a REST API. For example, one or more of the standardized APIs 108 may implement a Simple Object Access Protocol (SOAP), a query language, procedure call, or other API framework. In some embodiments, the standardized APIs 108 provide a common HTTP endpoint for interacting with the platform 102 and the systems 106. The standardized APIs 108 may expose various functions, including, for example, functions related to managing the platform 102 and functions related to using a service of the platform 102 or the systems 106. The standardized APIs are further described below in FIG. 2.

The platform services 110 may include hardware and software used by the platform 102 to provide certain services (e.g., authentication services, key management, digital card services, hardware security modules, tenant management services, and other services) to platform users 104. Example services provided by the platform 102 are described in connection with FIG. 2.

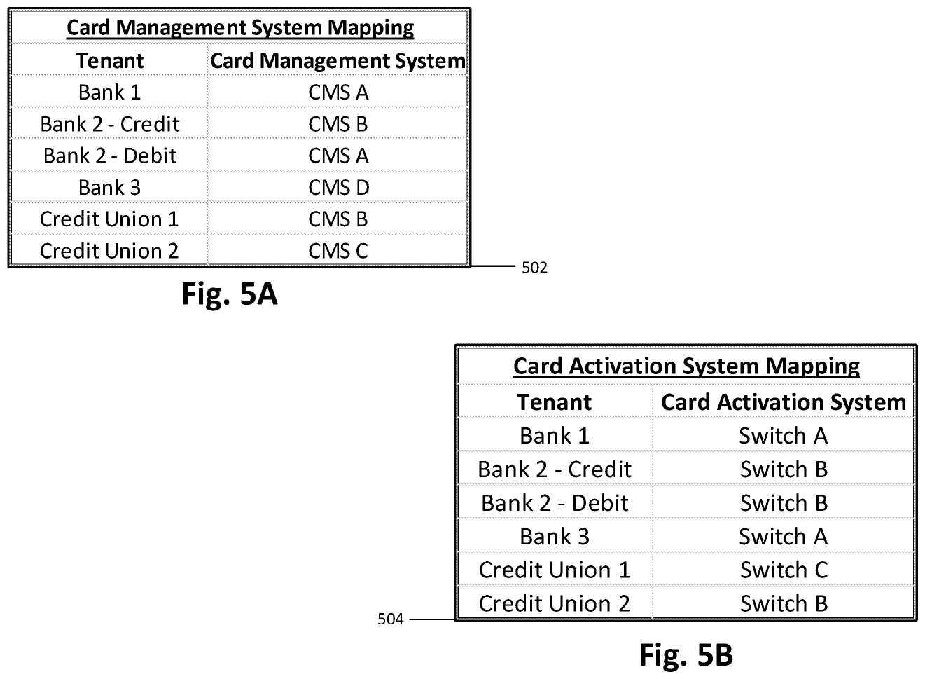

The tenant-system mapping 112, which may also be referred to as a registry service, may include data that maps tenants with the systems 106 and the platform services 110. The tenants may be platform users 104 or entities, such as financial institutions, associated with applications developed by the platform users 104. In some embodiments, the tenant-system mapping 112 includes a registry, or mapping data, that links tenants with one or more systems 106 and one or more platform services 110, as described further in connection with, for example, FIGS. 2 and 5. In some embodiments, the tenant-system mapping 112 is dynamic. For example, the tenant-system mapping 112 may be updated to reflect changes to tenants, systems, platform services, or the mapping between such components. In some embodiments, the tenant-system mapping 112 may execute a discovery process to identify new or updated systems, platform services, or tenants. Example aspects of the tenant-system mapping 112 are described in connection with FIG. 2.

The systems interface 114 may include software and hardware for interacting with the systems 106. The systems interface 114 may communicate with the systems 106 via APIs. In some embodiments, the systems interface 114 may include the interfaces provided by one or more of the systems 106, and at least some aspects of the systems interface 114 may be part of one or more of the systems 106, rather than the platform 102. In some embodiments, communicating with the systems 106 may require data that is formatted pursuant to requirements of the systems 106. For example, a first set of data having a first format may be required to interact with a card management system, and a second set of data having a second format may be required to interact with a card activation system. Furthermore, even among systems 106 that may offer similar or overlapping services, the types of data and the way in which that data is formatted may vary from one system to the next. For example, card management system X associated with a first entity may require different data types and formats than card management system Y associated with a second entity, even though such systems may offer similar services. However, as described herein, the platform 102 may be configured to not only determine an appropriate system of the systems 106 for a given request (e.g., a system mapped to a requesting tenant in the tenant-system mapping 112), but the platform 102 may also be configured to ensure that the data associated with the request is of a type and format required to communicate with the appropriate system.

The message coordinator 118 may coordinate the routing of messages (e.g., requests, response, updates, or other data) among the platform users 104, components of the platform 102, and the systems 106. In some embodiments, the message coordinator 118 may be part of a control or orchestration unit that facilitates operations among other components of the platform 108.

The transformation service 120 may format data to facilitate communication between components internal to the platform 102 and between components of the platform 102 and components that are external to the platform 102. The transformation service 120 may encrypt data that is sent from the platform 102 to external components, and the transformation service 120 may decrypt data that is received from external components. As an example, following receipt of a request, the transformation service 120 may format data according to a specification of one of the systems 106, such as a card management service, that is to fulfill the request. In some embodiments, the transformation service 120 may include a plurality of components, including, for example, an editor with a UI for configuring data transformations and a data store service.

Aspects of the platform 102 and the components 108-112 and 118-120 are further described herein, such as in connection with FIG. 2.

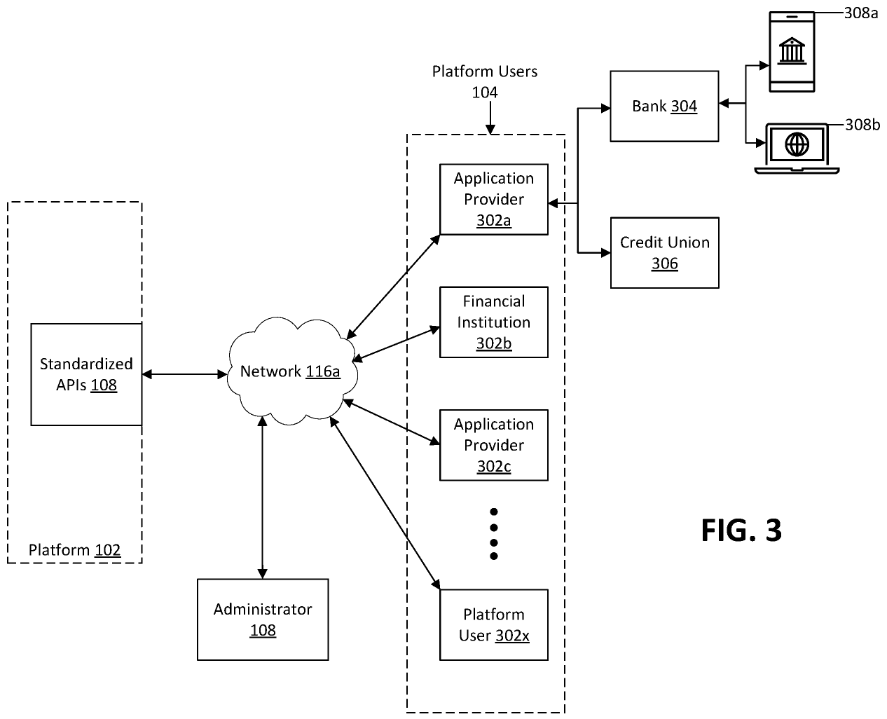

The platform users 104 may be one or more application providers that create, develop, or maintain software applications. The software applications may be, for example, web applications, mobile applications, another type of application, or a component of a software application. In some instances, the platform users 104 provide applications to financial institutions. In some instances, a platform user of the platform users 104 may itself be a financial institution. The platform users 104 may integrate services of the platform 102 into the software applications. To do so, the platform users 104 may interact with the platform 102 by developing against the standardized APIs 108. The platform users 104 are further illustrated and described below in connection with FIG. 3.

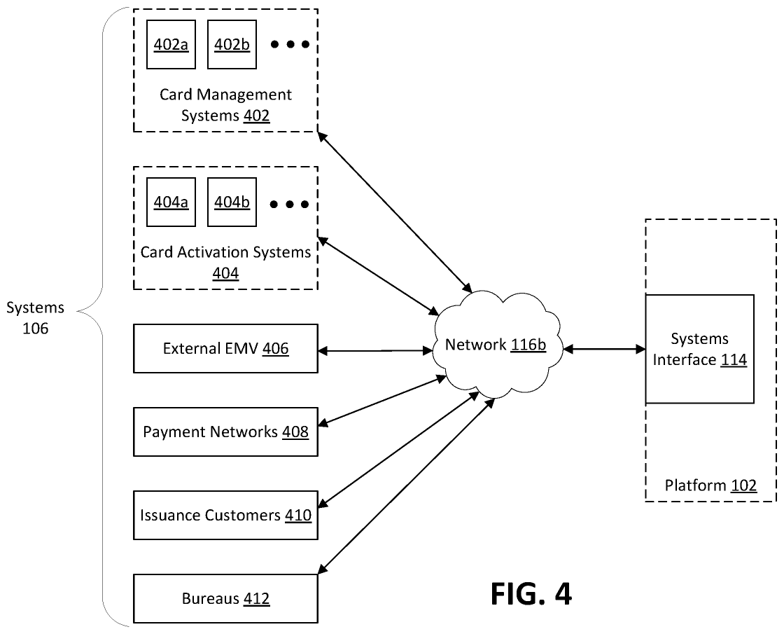

The systems 106 may include one or more systems that provide services related to payment cards (e.g., debit or credit cards), banking, finance, money exchange, or money management. In some instances, the systems 106 may include third-party systems, such as card management systems or card activation systems. In some embodiments, the systems 106 may also include systems that facilitate interactions with third-party systems. In some embodiments, some of the systems 106 may also be cloud-based systems or hybrid systems. The systems 106 are further illustrated and described below in connection with FIG. 4.

In the example of FIG. 1, the network 116a may communicatively couple the platform users 104 with the platform 102, and the network 116b may communicatively couple the systems 106 with the platform 102. The networks 116a-b may be, for example, wireless networks, wired networks, virtual networks, the internet, or another type of network. Furthermore, the network 116a-b may be divided into subnetworks, and the subnetworks may be different types of networks or the same type of network. In different embodiments, the network environment 100 can include a different network configuration than shown in FIG. 1, and the network environment 100 may include more or fewer components than those illustrated.

FIG. 2 illustrates a schematic block diagram of example aspects of the platform 102. As shown, the platform 102 may include standardized APIs 108, platform services 110, tenant-system mapping 112, systems interface 114, message coordinator 118, and transformation service 120, each of which may include one or more components, as shown in the example of FIG. 2.

The standardized APIs 108 may include one or more APIs that are exposed to programs that interact with the platform 102. Each API of the standardized APIs 108 may provide a service or functionality to the platform users 104. Advantageously, a calling program need not, in some instances, specify a system of the systems 106 or service of the platform services 110 that is to fulfill a request, nor must the calling program, in some instances, provide all required data in a required format for interacting with a downstream service. Instead, the platform 102 may, in some instances, identify a tenant associated with the calling program, identify a system associated with the tenant that can fulfill the request, and ensure that the data required to interact with a downstream service is provided to that service and formatted according to that service's requirements.

In the example shown, the standardized APIs 108 are displayed in groups, including administration APIs 201 authentication APIs 202, card APIs 204, and kiosk APIs 206. In some embodiments, a platform user of the platform users 104 may develop a program-such as an application for a financial institution—against one or more of these APIs. The program may be, for example, a mobile or web application for a bank. Additionally, the platform 102 may include more or fewer APIs than those illustrated in the example of FIG. 2. Yet still, in some embodiments, the standardized APIs 108 that are exposed to an application provider may vary depending on an access level that the application provider has with the platform 102.

In some embodiments, an application may call one of the administration APIs 201 to perform an administrative function performing to the platform 102. For example, an application used by an administrator may call the administration APIs 201 to perform one or more of the following: create a tenant; retrieve data from the transformation service 120, the mapping data 212, or the platform services 110; update a configuration file; retrieve diagnostic data; update a configuration of the message coordinator 118; add, remove, or update a configuration for one or more systems 106; update an authentication or security parameter; or perform another administrative function pertaining to the platform 102. In some embodiments, a separate set of API keys or other authentication mechanisms may be required for a program interacting with the administration APIs 201.

In some embodiments, a program may call one or more of the authentication APIs 202 for a service related to identification, authentication, or digital security. An authentication API of the authentication APIs 202 may expose a functionality such as identifying a user, verifying card data or payment data, authenticating a password, authenticating a key, performing multi-factor authentication, setting security passwords, or another function related to authentication, identification, or security.

In some embodiments, a program may call one or more card APIs 204 for a service related to a digital or a physical payment card. For example, a card API of the card APIs 204 may expose functionality such as making a payment using a card, generating or activating a new card, re-pinning a card, altering card data, altering an account associated with a card, performing an action related to card instant issuance, disputing a card transaction, canceling a card, or performing another action related to a card.

In some embodiments, a program may call one or more kiosk APIs 206 to request issuance a new physical card or to perform an operation related to a physical card.

In some embodiments, calling one of the standardized APIs 108 may require the same parameters, and may output the same data types, irrespective of the bank with which the calling application (e.g., a platform user 104) is associated, irrespective of what application provider developed the calling application, and irrespective of the systems 106 with which the calling application is linked. Such uniformity may, in some instances, enable an application provider to reuse code across applications for different financial institutions, thereby reducing costs for the application provider, allowing the application provider to develop applications for more clients, increasing the speed at which updates may be propagated, and reducing coding errors by minimizing the number of customized API calls.

Depending on which API is called, the platform 102 may call one or more of the platform services 110 or systems 106. In some embodiments, when an API is called, the calling program may provide data indicating a tenant for which the API call is made. As is described further below in connection with FIG. 3, a tenant may be an entity associated with a software program that uses one or more services of the platform 102. A tenant may be a financial institution, such as a bank, that offers an application that integrates services of the cloud platform 102.

The platform services 110 may include one or more services provided by the platform 102. In the example shown, the platform services 110 include the following services: key management 208a, device management 208b, financial instant issuance 208c, EMV data preparation 208d, identity services 208c, digital card services 208f, notification services 208g, licensing services 208h, and tenant management services 208i. In some embodiments, one or more of the platform services 110 may be communicated with via an API associated with the one or more services. In example embodiments, services related to digital card issuance may be performed as described in U.S. Provisional Patent App. No. 63/356,316, the disclosure of which is hereby incorporated by reference in its entirety. Furthermore, one or more of the services of the platform services 110 may use a hardware security module (HSM) to store data or to execute one or more processes (e.g., for storing or generating keys, decrypting data, or encrypting data). In some embodiments, the platform 102 may include more or fewer services than those illustrated. Furthermore, in some embodiments, one or more of the platform services 110 may be configured to handle a request received at one or more of the standardized APIs 108.

The tenant-system mapping 112, which may also be referred to as a registry service, may include mapping data 212 and a tenant-system mapping handler 214. In some embodiments, the mapping data 212 may be stored in a database, or the mapping data 212 may be one or more configuration files. The mapping data 212 may include data that links tenants to systems and services. For example, the mapping data 212 may indicate that a particular tenant is associated with a particular card management system. Thus, when a call is received from an application associated with that tenant to perform an operation requiring a card management system, the platform 102 may, based on the mapping data 212, call the linked card management system.

At the same time, the mapping data 212 may indicate that a second tenant is mapped to a different card management system. Thus, even though two tenants may use an application that has similar code (e.g., both tenants may use an application developed by a common application provider), they may be linked with different systems (e.g., different card management systems) based on the configuration of mapping data in the platform 102. As a result, requests received by the platform 102 may result in calls to different card management systems, even though the code for the applications that sent the requests is substantially similar, and even though the applications may have called the same API of the standardized APIs 108.

In some embodiments, the other services with which a tenant is linked may be independent of the card management system or card activation systems with which the tenant is associated. For example, two tenants may be linked to different card management systems or card activation systems, but they may use the same authentication, identification, digital card issuance, or other services offered by the platform 102. Additionally, in some instances, a particular tenant may be linked to a first card management system for the tenant's credit cards, for example, but with a second card management system for the tenant's debit cards, for example.

Furthermore, a tenant may be linked (and there may be corresponding mapping data in the mapping data 212) with other systems of the systems 106, such as card activation systems. Yet still, a tenant may be linked with services of the platform services 110. For instance, a first tenant may use certain authentication services (e.g., multi-factor authentication, password configurations, etc.), while a second tenant may use different authentication services offered by the platform 102. As another example, a first tenant may have access to each of the platform services 110, while a second tenant may only have access to certain services of the platform services 110. In some embodiments, the platform 102 may, in response to receiving an API call from a tenant to access a service, determine whether the tenant has access to the requested service based on mapping data of the tenant-system mapping 112.

The tenant-system mapping handler 214 may handle requests to edit the mapping data 212. For example, the platform 102 may receive a request to add a new tenant. For example, a platform user 104 may develop an application for a new client. As part of onboarding the new tenant, the platform 102 may receive data that indicates the systems and services with which the new tenant is linked, and may include authorization information allowing the tenant to be mapped to a particular selection of systems and services. The tenant-system mapping handler 214 may add to or update the mapping data 212 to reflect the requested configuration of the new tenant. For example, the onboarding or configuration data for the new tenant may indicate that the tenant is linked with card management system “A” for a first set of payment cards, with card management system “B” for a second set of payment cards, and with card activation system “C” for one or more of the tenant's cards. The onboarding or configuration data may also indicate that the tenant has access to services X, Y, and Z that are offered by the platform 102, and may include authorization data for communication with each of those services. Based on such data, the tenant-system mapping handler 214 may edit the mapping data so that the tenant is linked with the requested systems and services. Thus, when a request is received from that tenant, at one of the standardized APIs 108, the platform 102 will call the systems and services that are linked with that tenant.

The tenant-system mapping handler 214 may also update a mapping for existing tenants. As an example, a bank may want to change from a first card management system to a second card management system (or from a first card activation system to a second card activation system). The application provider for that bank (or the bank itself) may provide a request to the platform 102 to update the mapping for that bank so that the bank is linked with the second card management system. Having updated the mapping for that bank, the platform 102 will—in response to receiving a future request from an application associated with the bank to interact with the bank's linked card management system—call the second card management system.

In some embodiments, the tenant-system mapping 112 may onboard a new system of the systems 106. For example, an entity that performs one or more card-related services may register with the tenant-system mapping 112. As part of doing so, the new system may indicate services provided by that system, such as one or more of card management services, activation services, payment services, and so on. Having registered with the platform 102, the new system may then be accessed by platform users 104 via the platform 102. Advantageously, the platform 102 may thereby provide near immediate onboarding for new systems of the systems 106. In some embodiments, the platform 102 may perform a discovery process to seek additional systems to add to the systems 106, for example by polling or querying sources at which new systems may be registered.

Advantageously, even though a bank may change the card management system with which it is linked, the standardized APIs 108 offered by the platform 102 may be unchanged. Thus, the application provider for the bank need not, in some instances, reprogram the application for the bank to interact with the updated card management system. Thus, because the platform 102 may have developed the systems interface 114 with the systems 106 and because the platform 102 exposes the standardized APIs 108, the application providers may implement changes for their clients without significant application redevelopment, resulting in faster update times and significant reductions in costs associated with changing among various service-providing systems, such as the third party systems described herein (e.g., changing card management systems or card activation systems).

In some embodiments, the platform 102 may use the tenant-system mapping handler 214 as part of managing tenant permissions. For example, a tenant may have a license and/or various authorizations that grant access to each of the platform services 110. Accordingly, the mapping data 212 may indicate that this tenant has access to each of the platform services 110. Likewise, for a tenant that has access to less than all of the platform services 110, the mapping data 212 may indicate the services that the tenant may access. If a tenant changes its license (e.g., the tenant may access more or fewer of the platform services 110 or systems 106), then the tenant-system mapping handler 214 may update the mapping data 212 to reflect that the tenant has access to more or fewer platform services 110 or systems 106. In some embodiments, the tenant-system mapping handler 214 may, by controlling which tenants are mapped to which services and systems, provide a layer of security.

The systems interface 114 may be configured to communicate with each of the systems 106. As is further described below in connection with FIG. 4, the systems 106 may include various types of systems, which may have different communication protocols. For example, the APIs exposed by a first card management system may have different names, require different parameters, output different data, or offer different functionality than the APIs exposed by a second card management system. Furthermore, the architectural style of APIs may vary from system to system. While one system may offer REST APIs, another system may offer APIs that have a different structure, such as, for example, SOAP, GraphQL, RPC, or another type of API. As another example, some systems may require communications by exchanging structured data files, such as CSV files or XML files. As another example, some systems may require communications with a mainframe and/or a networking appliance (e.g., for providing a virtual private network (VPN)). Thus, the systems interface 114 may include customized code for interacting with each of the systems 106. Furthermore, as systems are coupled to, or decoupled from, the platform 102, the systems interface 114 may be updated to communicate with the updated configuration of the systems 106. Yet still, the systems interface 114 may also be updated in response to a change in the APIs exposed by an existing system of the systems 106.

The message coordinator 118 may coordinate the routing of messages between internal and external integration services. For example, for a given request received at the standardized APIs 108, the message coordinator 118 may determine which systems internal to the platform 102 and external to the platform 102 may be required to fulfill the request. This may include determining which programs to call so that the requisite data can be retrieved and formatted to fulfill the request. In some examples, the message coordinator 118 may execute business logic for routing data. In some embodiments, the message coordinator 118 (and other components of the platform 102) may use one or more of a message-based, queue-based, or topic-based protocol for communicating data.

The transformation service 120 may perform various services related to data storage, conversion, and management to facilitate communication between components internal to the platform 102 and with components external to the platform 102. As an example, the platform 102 may receive a request from an application at the standardized APIs 108 to perform a card management operation (or other service). As described further herein, the message coordinator 118 and the tenant-system mapping 112 may determine a tenant associated with the request and, based in part on data associated with the identified tenant, determine a system of the systems 106 for performing the card management operation. That system, however, may require data in a different format than the data provided at the standardized APIs 108 or retrieved from the tenant-system mapping 112. The transformation service 120 may be configured to determine the data field and formats required to interact with the determined system and then transform the data received at the standardized APIs 108 and from other components of the platform 102 into data fields and formats required to interact with the determined system. In the example shown, the transformation service 120 includes a transformation editor 216, a transformation data service 218, and a messaging transformer 220.

The transformation editor 216 may be configured to define transformations to apply to data. For example, the transformation editor 216 may be configured to define, for a given system of the systems 106, how data received from the standardized APIs 108 and from other components of the platform 102 is to be transformed to enable communication with the system. In some embodiments, the transformation editor 216 may include a user interface via which transformations may be defined by a user, such as an engineer or administrator of the platform 102. In some embodiments, the transformation editor 216 may be a web application. Advantageously, a user may, in some instances, use the transformation editor 216 to define transformations without needing to interact with source code, thereby converting a coding task performed by a software engineer into a configuration task that may be performed by someone without software development experience. Defining a transformation may, in some instances, be more similar to setting parameters of a configuration file than writing source code, thereby casing the user of the platform 102 for certain users and increasing the speed and case of onboarding or updating the systems 106.

The transformation data service 218 may be a system for managing, retrieving, and storing transformations. In some embodiments, transformations defined by the transformation editor 216 are stored at the transformation data service 218. In some embodiments, the transformation data service 218 is coupled with a continuous integrations and delivery pipeline that calls the transformation data service 218 to provide transformations to a production environment.

In some embodiments, the transformation data service 218 organizes transformations according to relevant fields. For example, the transformation data service 218 may provide a plurality of data fields according to which the stored transformations may be searched. As examples, the transformation data service 218 may enable transformations to be search by one or more of the following fields: a tenant; a system of the systems 106; a service; a platform user 104; a data format; or another field. In some embodiments, the transformation data service 218 enables flexible transformation selection for a given request. For example, for a given request, the transformation data service 218 may initially try to apply a tenant-specific or system-specific transformation; if, however, the transformation data service 218 is unable to apply tenant-specific or system-specific transformation (e.g., because such a transformation has not been defined), then the transformation data service 218 may apply a more generic transformation to the request. In some embodiments, the transformation data service 218 uses a cloud storage system. In some embodiments, the transformation data service 218 may use a MongoDB.

The messaging transformer 220 may perform data conversions based in part on transformations received from the transformation data service 218.

The platform 102 may include more or fewer components than those illustrated in the example of FIG. 2. For example, as described above, the platform 102 may include a control or orchestration component, such as the message coordinator 118, that facilitates coordination of tasks across the standardized APIs 108, the platform services 110, the tenant-system mapping 112, the systems interface 114, the message coordinator 118, the transformation service 120, and various subcomponents of these components illustrated in the example of FIG. 2. Yet still, in some embodiments, the architecture of the platform 102 may vary. For example, each of the components of the platform 102 may, in some instances, be directly communicatively coupled with one another. In some embodiments, functions described herein as being performed by a component may be performed by a different component or a plurality of components. Furthermore, in some embodiments, some components described herein may be distributed across a plurality of computing systems.

FIG. 3 illustrates a block diagram of aspects of the network environment 100. In the example of FIG. 3, the platform 102 is illustrated as communicatively coupled via the standardized APIs 108 and the network 116a with the platform users 104.

The platform users 104 may include entities that develop or provide software applications. The platform users 104 may develop applications against one or more of the standardized APIs 108 offered by the platform 102. In some embodiments, there may be various types of platform users 104. For instance, as shown in the example of FIG. 3, the platform users 104 include a first application provider 302a, a financial institution 302b, a second application provider 302c, and another type of platform user 302x. The application providers 302a and 302c may develop software applications for clients or customers. The software applications may provide bank or money-related functionality to end users.

For example, the application provider 302a may develop one or more applications for each of the bank 304 and the credit union 306. The bank 304 may integrate the application developed by the application provider 302a with the bank's own data and systems and then provide the application to the end users 308a-b, which may be customers of the bank 304. As shown, the users 308a-b may be mobile or browser-based users of the application developed by the application provider 302a and offered by the bank 304. The users 308a-b may use the application offered by the bank 304 to perform services offered by the platform 102. For example, the users 308a-b may use the application to perform card operations (e.g., displaying a digital version of a card, activating a card, using a card, repining a card, etc.) or authentication operations (e.g., signing into an account, verifying identity, etc.).

Similar to the application provider 302a, the application provider 302c may also develop applications that are offered to clients. In some instances, a financial institution (e.g., the financial institution 302b) may develop at least some of its own software and may itself use functionality offered by the platform 102. As illustrated, in some instances, each of the platform users 104 may develop applications against one or more standardized APIs 108 offered by the platform 102.

In some embodiments, an application provider may become a licensed customer of the platform 102. As a licensed customer, the application provider may access the services offered by the platform 102, such as the platform services 110, which may include identity verification as a service, digital card issuance, and other services, as described above in connection with FIG. 2. A licensed application provider also has access to various systems with which the platform 102 is integrated, such as the systems 106, which include card management systems and switch integrations. Furthermore, a licensed application provider may be provided keys that may be used when accessing the standardized APIs 108.

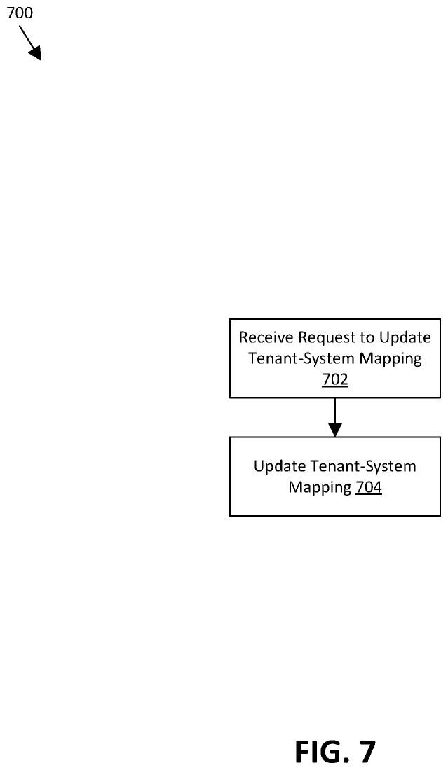

In some embodiments, an application provider may register its clients with the platform 102. In some embodiments, each client of an application provider is a tenant in the platform 102. When an application provider is associated with a tenant, the platform 102 may permit the application provider to alter a mapping with a third-party system on the tenant's behalf. For example, the bank 304 may be initially configured to use a first card management system (or card activation system) for the card services that the bank 304 offers to its customers. The bank 304 may, however, decide to change the card management that it is using (e.g., because of a business decision, because of a merger or spin off, because of technical considerations, or because of another reason). The application provider 302a may, in some instances, notify the platform that the bank 304 is switching from the first card management system to a second card management system. The platform 102 may verify that the application provider 302a is authorized to make such a change on behalf of the bank 304, and then the platform 102 may update a mapping for the bank 304 from the first card management system to the second card management system, a process that is further described above in connection with FIG. 2 and below in connection with FIG. 7.

The administrator 310 may be an application that is used by or otherwise associated with an entity that develops, maintains, or operates the platform 102. In some embodiments, the administrator 310 interacts with the administration APIs 201 of the platform 102.

FIG. 4 illustrates a block diagram of aspects of the network environment 100. In the example of FIG. 4, the platform 102 is illustrated as communicatively coupled via the systems interface 114 and the network 116b with the systems 106, which may be considered integrations that are provided by the platform 102 to the platform users 104.

The systems 106 may include one or more systems that provide services related to payment cards (e.g., debit or credit cards), banking, finance, money exchange, or money management. In the example shown, the systems include card management systems 402, card activation systems 404, external EMV systems 406, payment networks 408, issuance customers 410, and bureaus 412. In some embodiments, one or more of the systems 402-412 may be third-party systems (e.g., they may be offered by—or otherwise associated with—an entity, such as an organization or company, that is different than the entity that offers, or is otherwise associated with, the platform 102). For example, one or more of the card management systems 402, the card activation systems 404, the external EMV systems 406, or payment networks 408 may be third-party systems or may interact with third-party systems. Additionally, in some embodiments, one or more of the systems 402-412 may also be a cloud-based system.

The card management systems 402 (CMS) may include a plurality of different card management systems, such as the card management system 402a, the card management system 402b, and so on. A card management system may provide services related to issuing and updating settings associated with credit and debit cards. In some embodiments, a card management system may also handle (e.g., receive, store, process, generate, send, etc.) cardholder information. In some embodiments, the card management systems 402 may include a smart card management system. Example card management systems include card management systems provided by Fiserv, Jack Henry, Finastra, or another entity. As described above in connection with FIG. 2, card management systems of the card management systems 402 may expose differing APIs and interfaces and may offer different services. In some embodiments, two or more card management systems of the card management systems may be offered by, or otherwise associated with, a common entity.

The card activation systems 404 (Switches) may include a plurality of different card activation systems, such as the card activation system 404a, the card activation system 404b, and so on. A card activation system may provide services related to activating or deactivating a credit or debit card. In some embodiments, a card activation system may activate a card as a part of an instant financial issuance service offered by the platform 102. Example card activation systems may include systems provided by Fiserv, Jack Henry, Finastra, or another entity. As described above in connection with FIG. 2, card activation systems of the card activation systems 404 may expose different APIs and interface, and card activation systems may offer different services.

The external EMV systems 406 may, for example, provide services related to preparing and personalizing data in accordance with the EMV (Europay, Mastercard, and Visa) standard. In some embodiments, such data may be integrated onto a card when the card is issued. For example, for a physical card, hardware, software, and data may be integrated onto a smart chip on the physical card.

The payment networks 408 may include one or more networks that process payments. Example networks include Visa, Mastercard, American Express, Discover, or another payment network.

Each of the issuance customers 410 and bureaus 412 may include trusted end points with which the platform 102 may communicate. In some embodiments, the platform 102 may use one or more of the issuance customers 410 or the bureaus 412 to communicate with a card management system or a card activation system.

FIGS. 5A-5B illustrate example mapping data 502-504 that may be used by the platform 102. The mapping data 502-504 may be example mapping data stored in the mapping data 212. As described above in connection with FIG. 3, the platform 102 may serve multiple tenants, and a tenant may be a financial institution associated with an application that integrates a service of the platform 102. Example tenants are illustrated in the mapping data 502-504. In addition to the data shown, the platform 102 may also store other data for a tenant, such as an application provider that develops the tenant's application, other services that the tenant uses (e.g., identification or authentication services), customizable configuration details for a tenant, or other data related to the tenant. In some embodiments, the mapping data 502-504 may also include data about the card management systems or the card activation systems, such as the systems' names, the entities that offer the systems, details for how to interface with the systems, or other systems information.

FIG. 5A illustrates example mapping data 502. The mapping data 502 provides mappings between tenants and card management systems. In the example shown, “Bank 1” is linked with the card management system CMS A. Thus, when the platform 102 receive requests for Bank 1's customers, the platform 102 may call the CMS A when services of a card management system are requested. Continuing with the example of the mapping data 502, a tenant, Bank 2, may be mapped to different card management systems, CMS B for its credit cards and CMS A for its debit cards. As described above, the platform 102 can, in response to receiving a request either from a tenant or a tenant's application provider, update the mapping data 502 to change the card management system with which the tenant is linked.

FIG. 5B illustrates example mapping data 504. The mapping data 504 provides mappings between tenants and card activation systems, or switches. In the example shown, the “Bank 1” is linked with Switch A as Bank 1's card activation system. Thus, when the platform 102 receive requests for Bank 1's customers, the platform 102 may call the Switch A when services of a card activation system are requested. Continuing with the example of the mapping data 504, a tenant, such as Bank 2, may be linked with multiple card activation systems. As described above, the platform 102 can, in response to receiving a request either from a tenant or a tenant's application provider, update the mapping data 504 to change a card activation system with which the tenant is linked.

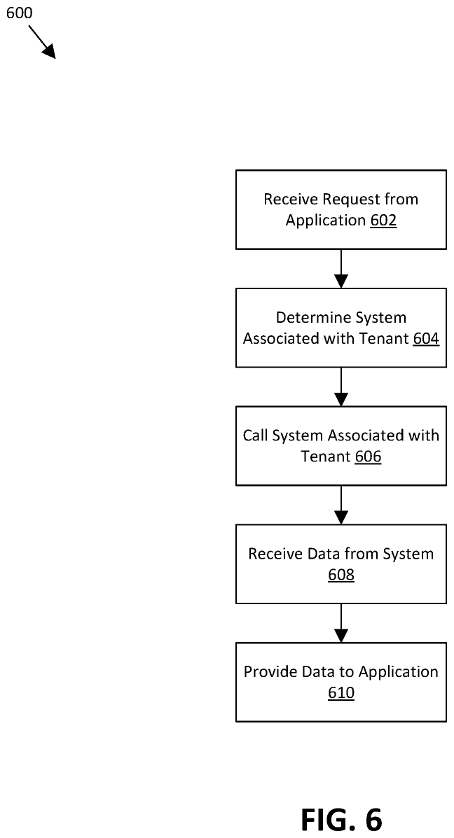

FIG. 6 is a flow diagram of an example method 600 that may be performed by the platform 102.

In the example shown, the platform 102 may receive a request from an application (step 602). In some embodiments, the request may be sent by a user of an application that is associated with a financial institution. In some embodiments, the application may be developed by an application provider. In some embodiments, the request may relate to performance of a service related to a card (e.g., a credit or debit card), a payment, a financial service, or another money-related service. To fulfill the request, the platform 102 may call a service or system with data from the request, such as one or more of the platform services 110 or the systems 106. Determining which services or types of systems to call may depend on which API offered by the platform 102 was called by the requesting application. Furthermore, determining which service or system to call may depend on the request type received. For example, the type of request may be for a card management service, a payment operation, a card settings operation, and so on. The platform 102 may determine the request type and based on the request type (and the services offered by the systems 106), the platform 102 may identify a type of system of the systems 106 that is to be called. In some embodiments, the application may have called an API exposed by the platform 102 to provide the request, such as one or more of the standardized APIs 108, examples of which are further described above in connection with FIG. 2.

In the example shown, the platform 102 may determine a system associated with the tenant (step 604). To do so, the platform 102 may use the mapping data 212. For example, the request may be for a service that requires use of a card management system (or a card activation system). The platform 102 may determine which card management system of a plurality of card management systems is linked with the tenant associated with the request. For instance, if the request is from a customer of Bank 1, then the platform 102 may determine, based on the mapping data, which card management system is linked with Bank 1. As another example, the request may be for one or more of the platform services 110, and the platform 102 may determine whether the tenant has access to the requested platform service.

In the example shown, platform 102 may call the system associated with the tenant (step 606). For example, the platform 102 may call the system that was determined in the step 604. In some embodiments, the platform 102 may provide data to a system that is configured to interact with the called system (e.g., the platform 102 may provide data to a trusted endpoint that is configured to communicate with a card management system or a card activation system). In some embodiments, the platform 102 may provide data that was received via a standardized API to the system. In some embodiments, the platform 102 may use the systems interface 114 to call the system.

In the example shown, the platform 102 may receive data from the called system (step 608). The data may be responsive to the request sent to the called system. In some embodiments, the platform 102 may receive the data via the systems interface 114. The data may be, for example, a confirmation that an operation was performed, data related to a card (e.g., a card number, card issuer data, cardholder data, security data, card activation or deactivation data, etc.), or other data relate to a service that may be provided by one or more of the systems 106 or platform services 110.

In the example shown, the platform 102 may provide data to the application from which the request was received (step 610). The data may include, for example, the data received by the platform 102 from the called system. In some embodiments, the platform 102 may—rather than providing the data to the application that sent the request—provide data to another system for further processing.

FIG. 7 is a flowchart of an example method 700 that may be performed by the platform 102.

In the example shown, the platform 102 may receive a request to update the tenant-system mapping data (step 702). For example, the platform 102 may receive a request from an application provider to update a mapping for a tenant that is associated with the application provider. The request may be received via one or more of the standardized APIs 108, or the request may be received via a different communication channel. For example, a developer or manager of an application provider may provide data to a developer or manager of the platform 102 to update the mapping data for a tenant.

In the example shown, the platform 102 may update the tenant-system mapping data (step 704). For example, the platform 102 may update the tenant-system mapping data in accordance with the request received to update the mapping data. For example, the tenant-system mapping handler 214 may update the mapping data 212 by changing or adding a system or service with which the tenant is linked.

As an example, if the tenant is a financial institution, the financial institution may have changed the partner entity that is performing backend card management services from entity X to entity Y. In such a case, the platform 102 may receive a request associated with the financial instruction that instructs the platform 102 to update the card management system mapping for the financial institution from entity X to entity Y. As a result, when subsequent requests are received from the tenant that require operations of a card management system, the platform 102 may convert data such that it can be received by entity Y, and the platform 102 may provide the converted data to the entity Y to perform an operation. Additional example aspects of updating tenant-system mapping are described in connection with FIG. 2.

Because the mapping data is updated, a tenant (or an application provider on behalf of a tenant) may update the card management system or switch that is used by the tenant without significant redevelopment of the application code. For example, the application provider need not redevelop an interface to be compatible with an updated card management system or switch. Instead, the application may, in some instances, continue to use the standardized APIs offered by the platform 102. The platform 102 may then use the mapping data to account for the change in the tenant's partner card management system or card activation system and assure that the requests associated with the tenant are sent to the appropriate system.

As a result, an application provider may save significant time and costs that may otherwise be spent in transitioning a client from a first card management system or card activation system to a second card management system or card activation system. Yet still, in some instances, such an update may not require significant development efforts for the platform 102 either, because the systems interface 114 may already be configured to communicate with the new card management system or card activation system. Other possible advantages of the present disclosure include ease of integration for application providers, standardized services and interfaces for financial institutions to expose services for card management to their customers, lower switching costs between different card management systems and switches by financial institutions.

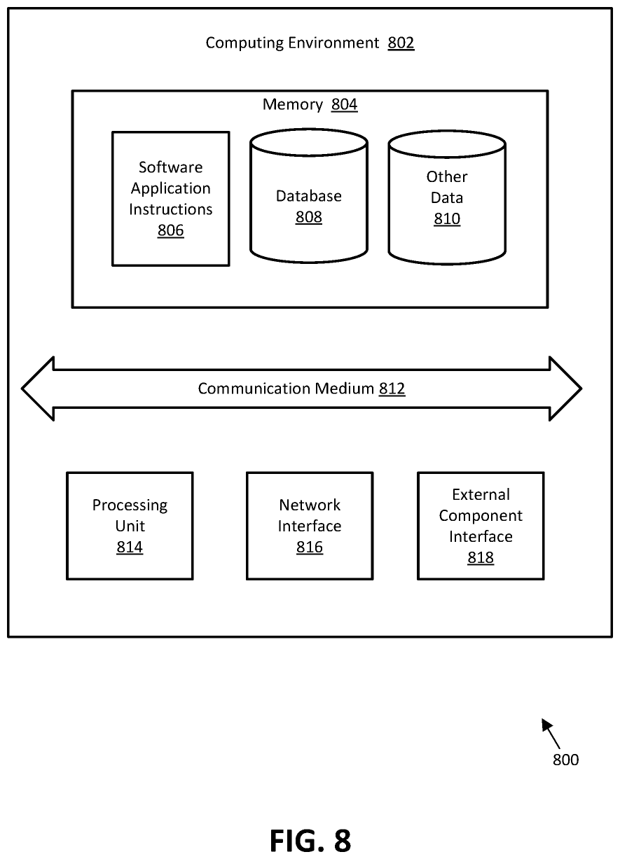

FIG. 8 illustrates an example system 800 with which disclosed systems and methods can be used. In an example, the following can be implemented in one or more systems 800 or in one or more systems having one or more components of system 800: the platform 102, the platform users 104, the systems 106, the standardized APIs 108, the platform services 110, the tenant-system mapping 112, the systems interface 114, the APIs 202-206, the services 208a-h, the hardware security module (HSM) 210, the mapping data 212, the tenant-system mapping handler 214, the platform users 302a-x, the end users 308a-b, the systems 402-412, the mapping data 502-504, and other aspects of the present disclosure. In some embodiments, the HSM 210 may include secure, tamper-resistant hardware devices that secure cryptographic processes by generating, protecting, and managing keys used for encrypting and decrypting data and for creating digital signatures and certificates.

In an example, the system 800 can include a computing environment 802. The computing environment 802 can be a physical computing environment, a virtualized computing environment, or a combination thereof. The computing environment 802 can include memory 804, a communication medium 812, one or more processing units 814, a network interface 816, and an external component interface 818.

The memory 804 can include a computer readable storage medium. The computer storage medium can be a device or article of manufacture that stores data and/or computer-executable instructions. The memory 804 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 804 can store various types of data and software. For example, as illustrated, the memory 804 includes software application instructions 806, one or more databases 808, as well as other data 810. The communication medium 812 can facilitate communication among the components of the computing environment 802. In an example, the communication medium 812 can facilitate communication among the memory 804, the one or more processing units 814, the network interface 816, and the external component interface 818. The communications medium 812 can be implemented in a variety of ways, including but not limited to a Peripheral Component Interface (PCI) bus, a PCI express bus accelerated graphics port (AGP) bus, a serial Advanced Technology Attachment (ATA) interconnect, a parallel ATA interconnect, a Fiber Channel interconnect, a USB bus, a Small Computing System Interface (SCSI), or another type of communications medium.

The one or more processing units 814 can include physical or virtual units that selectively execute software instructions, such as the software application instructions 806. In an example, the one or more processing units 814 can be physical products comprising one or more integrated circuits. The one or more processing units 814 can be implemented as one or more processing cores. In another example, one or more processing units 814 are implemented as one or more separate microprocessors. In yet another example embodiment, the one or more processing units 814 can include an application-specific integrated circuit (ASIC) that provides specific functionality. In yet another example, the one or more processing units 814 provide specific functionality by using an ASIC and by executing computer-executable instructions.

The network interface 816 enables the computing environment 802 to send and receive data from a communication network. The network interface 816 can be implemented as an Ethernet interface, a token-ring network interface, a fiber optic network interface, a wireless network interface (e.g., Wi-Fi), a Bluetooth interface, or another type of network interface.

The external component interface 818 enables the computing environment 802 to communicate with external devices. For example, the external component interface 818 can be a USB interface, Thunderbolt interface, a Lightning interface, a serial port interface, a parallel port interface, a PS/2 interface, or another type of interface that enables the computing environment 802 to communicate with external devices. In various embodiments, the external component interface 818 enables the computing environment 802 to communicate with various external components, such as external storage devices, input devices, speakers, modems, media player docks, other computing devices, scanners, digital cameras, and fingerprint readers.

Although illustrated as being components of a single computing environment 802, the components of the computing environment 802 can be spread across multiple computing environments 802. For example, one or more of instructions or data stored on the memory 804 may be stored partially or entirely in a separate computing environment 802 that is accessed over a network. Depending on the size and scale of the computing environment 802, it may be advantageous to include one or more load balancers to balance traffic across multiple physical or virtual machine nodes. Each node may be configured to be capable of running the full system 800. The environment 802 may include monitoring technology to determine when a node is not functioning so an appropriate action can be taken.

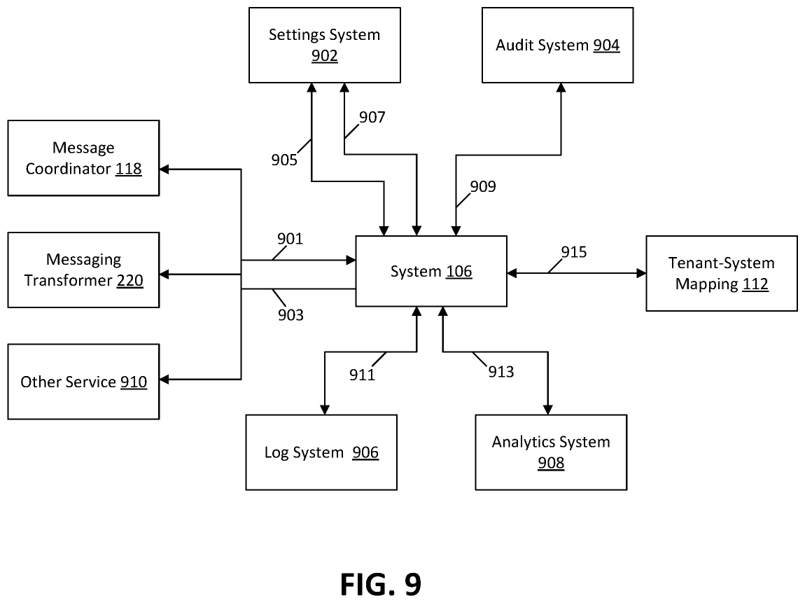

FIGS. 9-14 illustrate example operations representing data communication among components of the network environment 100, including components of the platform 102, the platform users 104, and the systems 106. In some embodiments, at least some of the operations illustrated may be performed following receipt of a request at the platform 102 from a platform user 104. Some operations, however, may be performed independent of any request received from the platform users 104. In some embodiments, the communications illustrated may be asynchronous. In some embodiments, the communications illustrated may, for a given request, be repeated or may be repeated over multiple requests. In some embodiments, the Advanced Message Queuing Protocol (AMQP) is used to facilitate communication among components. In other embodiments, different communication protocols may be used.

FIG. 9 illustrates example communications between the systems 106 and other components. The system 106 depicted in the example of FIG. 9 may be one or more of the systems 106 described in connection with FIG. 4. For example, as described in connection with FIG. 9, the systems 106 may be a particular card management system, card activation system, payment network, or other system. In some embodiments, communications related to one or more of the systems 106 may be configured differently than described in connection with FIG. 9.

At operation 901, the system 106 may receive an inbound request. In some embodiments, the request may be received from the systems interface 114. In some embodiments, the request may be sent from one or more of the message coordinator 118, the messaging transformer 220, or another service 910. The request type received at the operation 901 may depend on the services provided by the system 106. The request may include a request name and parameters for fulfilling the request. As an example, the system 106 may be a card management service. The request may relate to getting card details, and the parameters for the request may include an identifier of one or more of a card, pin, account, tenant, or user. The request may also include credentials or other data related to retrieving card details. As will be understood, different parameters may be used for other requests. For example, a request sent to a card activation system may include an identification of a payment network with which the card is to be associated and registration details for one or more users to be authorized.

At operation 903, the system 106 may output a response. For example, the system 106 may provide a response to the system that provided the request at the operation 901. Continuing with the example, if the system receives a request for card details at the operation 901, the system 106 may use the parameters provided in the request to look up the card details and to authorize that the requesting user can access the card details. The system 106 may then return the requested card details to the calling program or to another program specified in the request that is to receive the card details.

At operation 905, the system 106 may request and receive settings from the settings system 902. In some embodiments, the system 106 may only request and receive settings from the settings system 902 if the system 106 is internal to the platform 102, such as if the system 106 is developed, maintained, licensed, or otherwise associated with a common entity as the platform 102. However, in some embodiments, if the system 106 is external to the platform 102, then the system 106 may not receive settings directly from the settings system 902. Instead, a different component (e.g., the systems interface 114) may receive settings from the settings system 902 that enable communication with the system 106. In some embodiments, the settings system 902 may include a repository of settings for the system 106 or a component that communicates with the system 902. In some embodiments, the settings system 902 may include credentials or secrets that may be used by the system 106 or a component that communicates with the system 902. In some embodiments, altering the settings for the system 106 may include updating a configuration file or other parameter stored by the settings system 902, which may then provide the update to the system 106. In some embodiments, the settings system 902 may be communicatively coupled with a plurality of systems 106, one or more of which may share common configuration files provided by the settings system 902. In some embodiments, the system 106, or a system that communicates with the system 106, may call the settings system 902 at startup to retrieve settings or to determine whether there are any relevant updates to the settings.

At operation 907, the settings system 902 may provide a settings update to the system 106 or an internal system that communicates with the system 106. For example, the system 106 may be subscribed to the settings system 902 such that an update to the settings system 902 causes the settings system 902 to push the update to other systems, such as the system 106 or a system that communicates with the system 106.

At operation 909, data may be exchanged between the system 106 and the audit system 904. In some embodiments, the audit system 904 is a system that is external to the system 106 and is associated with an entity that audits the system 106 or an entity associated with the system 106. In some embodiments, the system 106 is configured to provide technical or financial data to the audit system 904 pursuant to a request received at the operation 909.

At operation 911, the system 106 may exchange data with a log system 906. The log system 906 may be used to record activity related to data exchanges pertaining to the system 106, such as data related to requests received by the system 106, responses generated by the system 106, or communications with other systems. Additionally, in some embodiments, the system 106 may log other activity pertaining to the system 106, such as errors, security-related events, performance metrics, system events, or other events that the system 106 is configured to log.

At operation 913, the system 106 may exchange data with the analytics system 908. In some embodiments, log data from the log system 906 is provided to the analytics system 908. In some embodiments, the system 106 may provide other data in addition to log data to the analytics system 908. In some embodiments, the analytics system 908 may analyze, search, or monitor data received from the system 106 to detect patterns, events, or anomalies. In some embodiments, the analytics system may include dashboards or other reporting tools for a user to view analytics data. In some embodiments, the analytics system 908 may use Splunk.

At operation 915, the system 106 may exchange data with the tenant-system mapping 112. For example, when the system 106 is initially onboarded to operate with the platform 102, the system 106 may provide its configuration details to the tenant-system mapping 112. As an example, the system 106 may inform the tenant-system mapping 112 about its supported features and the data types, formats, and credentials to use the system 106. In some embodiments, data exchanges between the system 106 and the tenant-system mapping 112 may accelerate the onboarding process if the system 106 is newly connecting to the platform 102 (of if the system 106 has been updated). For example, onboarding the system 106 may, in some instances, comprise informing the tenant-system mapping 112 of the services provided by the system 106 and informing the platform 102 of the data fields and formats required for communicating with the system 106. Using this information, the platform 102 may enable platform users to access services offered by the system 106, even though the platform users may not alter the calls made to the APIs 108 of the platform 102, thereby obviating the need, in some instances, for substantial software development efforts on the part of each of the platform users 104, the platform 102, and the system 106.

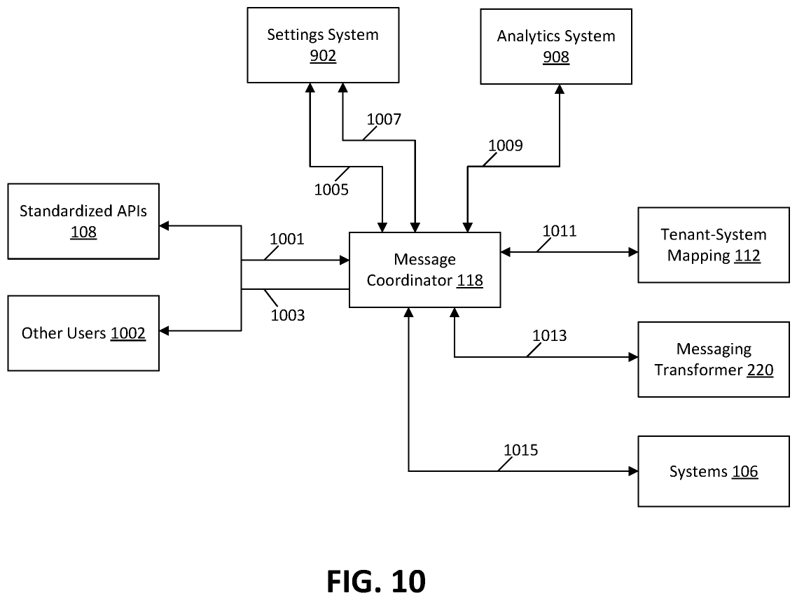

FIG. 10 illustrates example communications between the message coordinator 118 and other components.

At operation 1001, the message coordinator 118 may receive an inbound request via one or more of the standardized APIs 108 or from other users. In some instances, the inbound request includes a single request, whereas in other instances, the inbound request may include multiple requests. The inbound request may include, for example, a request to use a service of one or more of the systems 106 or of the platform 102. Example aspects of receiving an inbound request are described in connection with operation 602 of FIG. 6 and in connection with other FIGS described herein.

At operation 1003, the message coordinator 118 may output a response. The response may include data that is responsive to the one or more requests received at the operation 1001. As an example, the message coordinator 118 may coordinate the exchange of data and execution of operations in the platform 102 and the systems 106 to generate a response to the request. In some embodiments, the outbound response may be to the program that provided the inbound request or to a program designated in the inbound request to receive the response. Example aspects of providing an outbound request are described in connection with operation 610 of FIG. 6 and in connection with other FIGS described herein.

At operation 1005, the message coordinator 118 may request and receive settings from the settings system 902. At operation 1007, the settings system 902 may provide a settings update to the message coordinator 118. Example aspects of the operations 1005 and 1007 are described in connection with operations 905 and 907, respectively, of FIG. 9.

At operation 1009, the message coordinator 118 may exchange data with the analytics system 908. In some embodiments, the message coordinator 118 may log activity, and the message coordinator 118 may provide this log data to the analytics system 908. Example aspects of the operations 1009 are described in connection with the operation 913 of FIG. 9.

At operation 1011, the message coordinator 118 may query the tenant-system mapping 112 to retrieve data related to mappings between tenants and the systems 106. For example, the message coordinator 118 may receive a request (e.g., at the operation 1001) to perform a service for a platform user. That request may include an identifier of a tenant. Using this identifier of the tenant, the message coordinator 118 may query the tenant-system mapping 112 to determine systems of the systems 106 that are linked with that tenant to perform the requested service. In response to receiving the query, the tenant-system mapping 112 may identify and return an identifier of the systems or services that are linked to that tenant.

At operation 1013, the message coordinator 118 may send a request to the messaging transformer 220 to convert data so that it can be used by a downstream program. For example, the message coordinator 118 may request the messaging transformer 220 to convert data received or derived from a user request (e.g., at the operation 1001) into a format that can be received by a system that is identified (e.g., at the operation 1011) to perform that request. Additionally, the message coordinator 118 may provide additional parameters that may be used by the messaging transformer 220 that may be required by the messaging transformer to convert data. In response to receiving a data conversion request, the messaging transformer 220 may convert the data so that it can be ingested by an identified system. To do so, the messaging transformer 220 may use a schema or process that is defined for the identified system or for the tenant-system pairing.

At operation 1015, the message coordinator 118 may send a request to one or more of the systems 106 and receive a response from one or more of the systems 106. Example aspects of the operations 1015 are described in connection with the operations 901 and 903 of FIG. 9. Based at least in part on a response from the system 106, the message coordinator 118 may output a response to an external program.

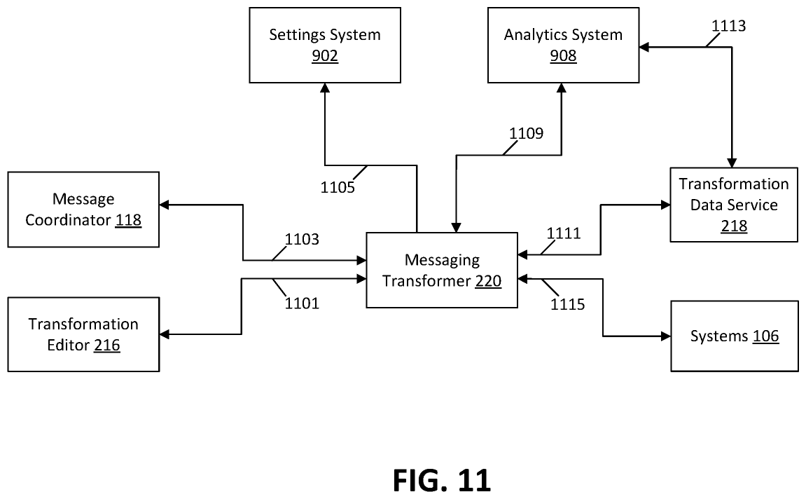

FIG. 11 illustrates example communications between the messaging transformer 220 and other components.

At operation 1101, the messaging transformer 220 may receive transformations from the transformation editor 216. The transformations may be used by the messaging transformer to format data so that it can be used by downstream systems, such as the systems 106. In some embodiments, the transformations may include a schema, template, or process for converting data.

At operation 1103, the messaging transformer 220 may receive a request from the message coordinator 118 to transform data. The request may include both data that is to be transformed and an identification of a tenant or system related to the data. After applying a transformation, the messaging transformer 220 may provide converted data to the message coordinator 118.

At operation 1105, the messaging transformer may receive a setting or configuration from the settings system 902. Example aspects of the operation 1105 are described in connection with the operations 905 and 907 of FIG. 9.

At operation 1109, the messaging transformer 220 may exchange data with the analytics system 908. The analytics system 908 may analyze log data recorded by the messaging transformer 220 or other data pertaining to the messaging transformer 220. Additionally, at operation 1113, the transformation data service 218 and the analytics system 908 may exchange data. The analytics system 908 may be configured to analyze queries to the transformation data service 218, data returned by the transformation data service 218, data stored by the transformation data service 218, and other data. Example aspects of the operation 1109 are described in connection with the operation 913 of FIG. 9.

At operation 1111, the messaging transformer 220 may request a transformation from the transformation data service 218 or store a transformation in the transformation data service 218. When requesting a transformation, the messaging transformer 220 may use one or more of a plurality of data fields for retrieving the transformation, and the transformation data service 218 may be configured to execute logic to identify one or more transformations to return, as described in connection with FIG. 2.

At operation 1115, the messaging transformer 220 may exchange data with the systems 106. For example, the messaging transformer 220 may send data corresponding to a request received at the platform 102 to a system of the systems 106 identified by the message coordinator 118 and the tenant-system mapping 112 and for which the messaging transformer 220 may apply a transformation to convert data. In some embodiments, the system 106 may return a response to the messaging transformer 220.

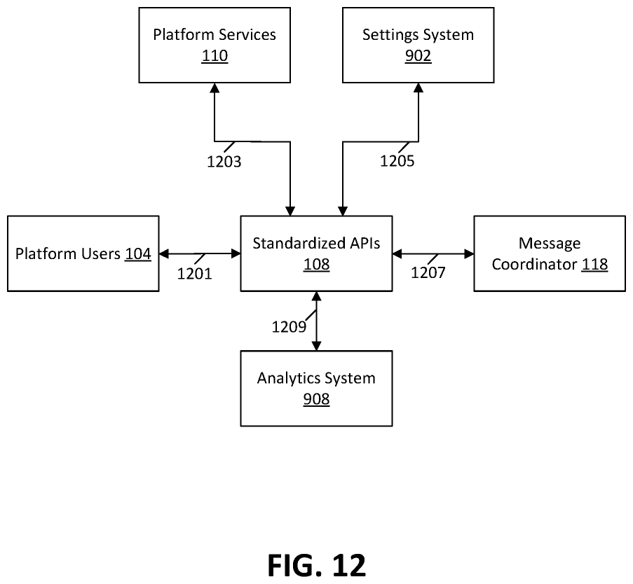

FIG. 12 illustrates example communications between the standardized APIs 108 and other components.

At operation 1201, platform users 104 may provide requests to one or more of the standardized APIs 108. For example, an application may call the standardized APIs 108 to perform a service related to a payment card, payment network, or other service, as described at least in connection with FIGS. 2 and 3.

At operation 1203, the standardized APIs 108 may exchange data with the platform services 110. For example, the standardized APIs 108 may use one or more of the platform services 110 to perform a request received from the platform users 104. As examples, in response to receiving a call at the standardized APIs 108, a call may be made to the key management service 208a of the platform services 110 to perform authentication or another service. As another example, in response to receiving a call at the standardized APIs 108, a call may be made to the tenant management services 208i of the platform services 110 to retrieve or validate data corresponding to a tenant that made the call to the standardized APIs 108.

At operation 1205, the standardized APIs 108 may exchange data with the settings system 902. For example, the standardized APIs 108 may receive a configuration for one or more APIs from the settings system 902.

At operation 1207, data may be provided from the standardized APIs 108 to the message coordinator 118 to start processing a request. The data may include data received from the platform users 104, data retrieved from the platform services 110, data corresponding to a platform user of the platform users 104 that called the standardized APIs 108, or other data. In some embodiments, the standardized APIs 108 may receive a response from the message coordinator 118. The response may then be provided from the standardized APIs 108 to a calling program of the platform users 104.

At operation 1209, the standardized APIs 108 may exchange data with the analytics system 908. For example, the standardized APIs 108 may log activity, which may include requests, responses, operations, or other events at the standardized APIs 108. The log data may be provided from the standardized APIs 108 to the analytics system 908, which may analyze the log data, an example of which is described in connection with operation 913 of FIG. 9.

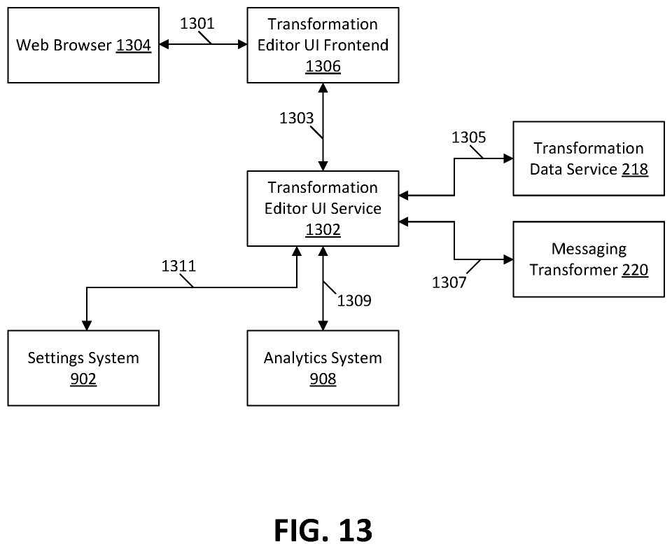

FIG. 13 illustrates example communications between components of the transformation service 120 and other components. The example of FIG. 13 includes various components of the transformation service 120, including the transformation data service 218 and the messaging transformer 220. Furthermore, in the example shown, the transformation editor 216 includes the transformation editor UI service 1302 and the transformation editor UI frontend 1306. For example, the transformation editor 216 may be a web application, and the transformation editor UI frontend 1306 may be a user interface that is provided to a web browser 1304 for interacting with the transformation service 120. In some embodiments, the transformation editor UI frontend 1306 is built at least in part using React or similar technology. The transformation editor UI front end 1306 may exchange data with the transformation editor UI service 1302 to retrieve data and access other components of the platform 102. Other configurations of the transformation editor 216 are likewise possible.

At operation 1301, the web browser 1304 may interact with the transformation editor UI frontend 1306. In some embodiments, the web browser 1304 is used by an administrator or other user to define transformations of the transformation service 120. For example, the user may define how requests and data included in requests are to be formatted for communicating with the systems 106. In some embodiments, the user may define the transformations using graphical user interface elements, such as text input fields, selectable menus, drag-and-drop features, or other elements. In some embodiments, a user may interact with the transformation editor UI frontend 1306 without using the web browser 1304. For example, if the transformation editor UI frontend 1306 includes a downloadable application, then the user may directly interact with the transformation editor UI frontend 1306. Advantageously, by enabling the definition of transformations with user interface elements, onboarding or updating a system configuration may be even faster. For example, rather than coding a new or updated transformation for a service, an administrator may define the transformation by using user interface components of the transformation editor UI frontend 1306.

At operation 1303, the transformation editor UI frontend 1306 and the transformation editor UI service 1302 may exchange data. For example, following a definition of a transformation via the web browser 1304, the transformation editor UI frontend 1306 may provide data for the new or updated transformation to the transformation editor UI service 1302. As other examples, the transformation editor UI service 1302 may provide data to the transformation editor UI frontend 1306 related to existing transformations, and these existing transformations may be viewed and edited by a user of the web browser 1304.

At operation 1305, the transformation editor UI service 1302 may exchange data with the transformation data service 218. For example, the transformation editor UI service 1302 may send a request to the transformation data service 218 to store a newly defined or updated transformation. Additionally, the transformation editor UI service 1302 may query and exchange data with the transformation data service 218 in response to a request from the transformation editor UI frontend 1306.

At operation 1307, the transformation editor UI service 1302 may exchange data with the messaging transformer 220. For example, the messaging transformer 220 may send a request to the transformation editor UI service 1302 for a transformation, and the transformation editor UI service 1302 may respond with the transformation.

At operation 1309, the transformation editor UI service 1302 may exchange data with the analytics system 908. For example, the transformation editor UI service 1302 may log activity data. The activity data may be provided to the analytics system 908, which may analyze the activity data. Example aspects of analyzing activity data are described in connection with operation 913 of FIG. 9.

At operation 1311, the transformation editor UI service 1302 may exchange data with the settings system 902. For example, the transformation editor UI service 1302 and the settings system 902 may exchange configuration data, examples of which are described in connection with operations 905 and 907 of FIG. 9.

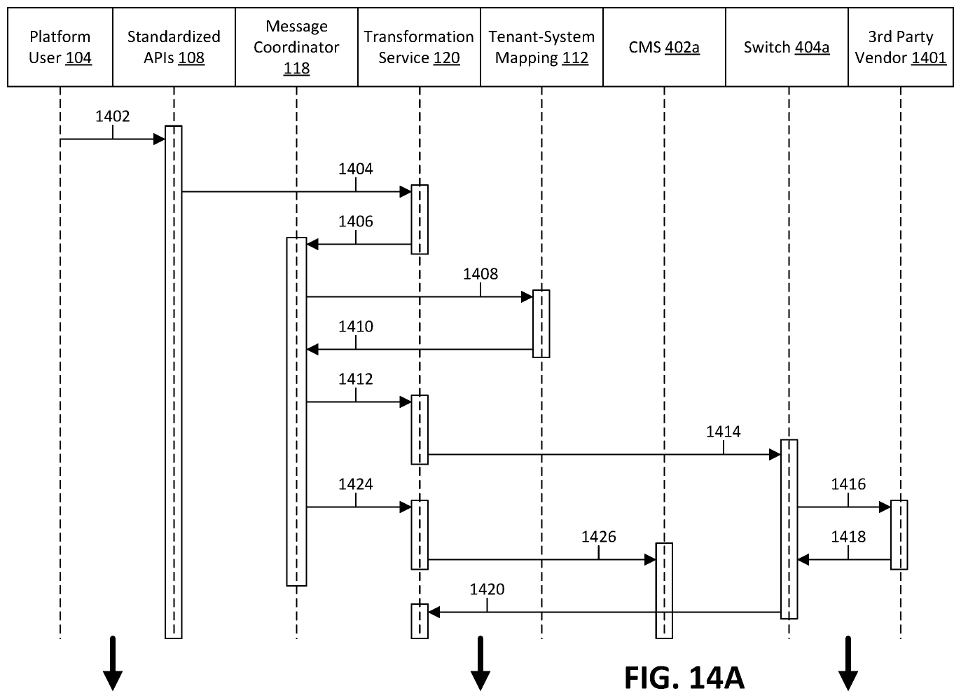

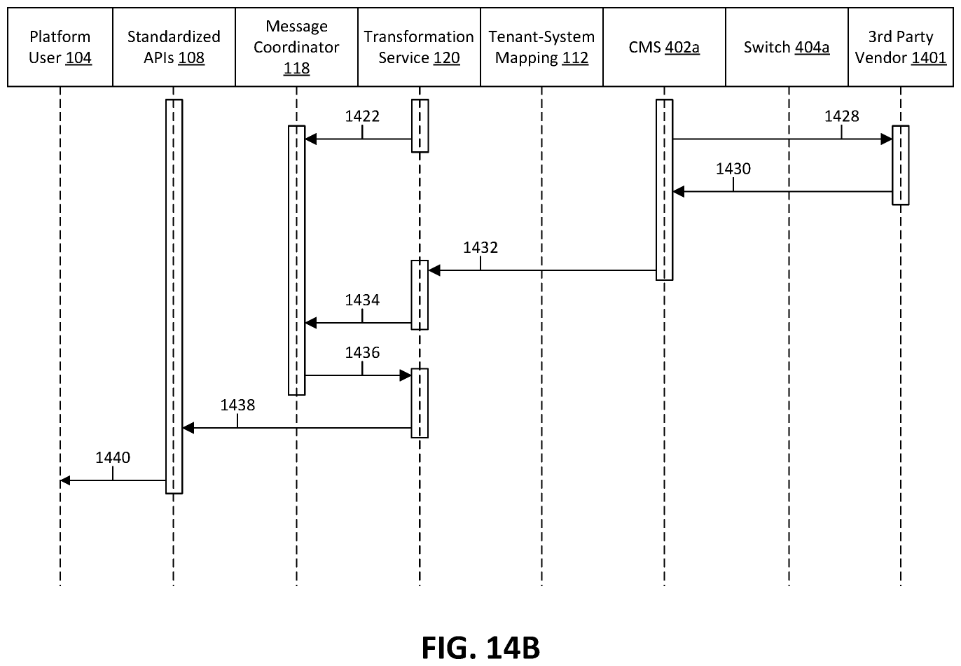

FIGS. 14A-B illustrate a schematic communication diagram including various components described herein. In the example of FIGS. 14A-B, an activate card command is received and executed. In response to receiving the activate card command, the platform 102 is configured to send requests to both a card management system (e.g., the CMS 402a) and to a card activation system (e.g., the switch 404a). In some instances, other requests to the platform 102 may include analogous data exchanges to those described in connection with FIGS. 14A-B. However, as will be understood, the transformations that are applied, the external systems 106 that are called, and other aspects of the FIGS. 14A-B may vary depending on the request that is received, depending on the tenant with which the request is associated, and depending on the embodiment of the platform 102 and other components.

At operation 1402, the platform user 104 may provide an activate card request to the standardized APIs 108. In some embodiments, the activate card request is an HTTP request and includes data that may be used by the platform 102 to identify or register a tenant that is activating the card.

At operation 1404, the transformation service 120 may receive the request from the standardized APIs 108. In response to receiving the request, the transformation service 120 may lookup a transformation associated with the request. For example, the transformation service 120 may lookup a transformation from the transformation data service 218. The transformation may relate, for example, to converting data of the activate card request to data that may be handled by other components of the platform 102. In some embodiments, the transformation may relate to decrypting the request or data from the request. After receiving the transformation, the transformation service 120 may apply the transformation, and at the operation 1406, the transformation service 120 may provide the output of the transformation to the message coordinator 118.

At operations 1408, the message coordinator 118 may query the tenant-system mapping 112 to identify systems that are associated with a tenant that sent the request at the operation 1402. For example, the message coordinator 118 may provide an identifier associated with the tenant and other data to the tenant-system mapping 112. In response, the tenant-system mapping 112 may identify the tenant and lookup the systems that are linked to the tenant. This may include identifying one or more systems of the systems 106 that are configured to perform the requested action (e.g., activate card) for the tenant. At operation 1410, the tenant-system mapping 112 may output data associated with the one or more linked systems to the message coordinator 118, such as an indicator as to what types of systems are linked to the tenant and the actions they may perform.

At operation 1412, the message coordinator 118 may query the transformation service 120 to transform data associated with the activate card request so that the data may be provided to one or more systems identified by the tenant-system mapping 112 as being linked to the requesting tenant. In response, the transformation service 120 may look up transformations for the linked systems and may apply the transformations, thereby converting the data to the appropriate format for downstream use. In the example shown, the transformation service 120 may lookup a transformation associated with the switch 404a and then apply that transformation. At operation 1414, the transformation service 120 may provide the transformed data to the switch 404a to perform an operation. Once the switch 404a receives the data and the request to perform the operation, the switch 404a may execute the request. This may include exchanging data with a third-party vendor 1401, which may be a service that is used by one or more of the systems 106 to execute a request, as illustrated by the operations 1416 and 1418.

At operation 1420, the switch 404a may return data to the transformation service 120. The data may include a confirmation that an action was taken (e.g., that a card has been activated) and any data pertaining to the operation, such as a new card number or other data. At operation 1422, the transformation service 120 may provide data received from the switch 404a to the message coordinator 118.

At operation 1424, the message coordinator 118 may query the transformation service 120 to transform data so that it can be provided to another system linked with the requesting tenant. For example, the message coordinator 118 may request that the transformation service 120 convert data to provide to the card management systems 402a. In response to receiving the request, the transformation service 120 may lookup a transformation associated with the CMS 402a and may apply the transformation. At operation 1426, the transformation service 120 may provide data to the CMS 402a along with a request to perform one or more actions related to activating a card.

As illustrated by the example of FIGS. 14A-B, certain operations may be performed while other operations are also being performed. As an example, as depicted by the operations 1416 and 1424, components internal to the platform 102, which may include the message coordinator 118 and the transformation service 120, may perform operations while other operations related to the activate card request are being performed, such as operations at the switch 404a. This parallel execution may increase the overall speed at which the user's request is processed.

At operations 1428 and 1430, the CMS 402a may perform one or more operations related to activating a card. In some instances, this may include interacting with the third-party vendor 1401 to perform one or more operations. In some embodiments, the third-party vendor 1401 may include different components or may encompass services offered by a plurality of entities. For example, the switch 404a may interact with a different component of the third-party vendor 1401 than the CMS 402a. At operation 1432, the CMS 402a may return a response to the transformation service 120. The response may include a confirmation that an action was performed by the CMS 402a and other data pertaining to an action performed by the CMS 402a. At operation 1434, the transformation service 120 may provide data to the message coordinator 118.

In the example shown, the message coordinator 118 may, at the operation 1422, receive data related to an action performed by the switch 404a, and the message coordinator 118 may, at the operation 1434, receive data related to an action performed by the CMS 402a. The message coordinator 118 may determine that aspects of the data are to be output the platform user 104 as a response via the standardized APIs 108. In the example shown, the message coordinator 118 may, at the operation 1436, provide data to the transformation service 120 that is to be output to the platform user 104.

The transformation service 120 may receive data from the message coordinator 118 and apply a transformation. The transformation may include encrypting the data and formatting it to be output via the standardized APIs 108 to the platform user 104. At operation 1438, the transformation service 120 may provide the transformed data to the standardized APIs 108. At operation 1440, the standardized APIs 108 may output data to the platform user 104. This data may relate to a result of the activate card action performed by the switch 404a and the CMS 402a.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A system for integrating digital financial services, the system comprising:
an application providing a financial service to a user;
a plurality of card management systems; and
a platform;
wherein the platform is communicatively coupled to the application;
wherein the platform is communicatively coupled to each card management system of the plurality of card management systems;
wherein the platform is configured to access a database storing mapping data, the mapping data including a mapping between the application and a linked card management system of the plurality of card management systems; and
wherein the platform includes a processor and memory, the memory storing instructions that, when executed by the processor, cause the platform to:
expose an application programming interface (API);
receive, via the API, a request from the application; and
based on the mapping between the application and the linked card management system, provide data associated with the request to the linked card management system.

2. The system of claim 1,
wherein the instructions, when executed by the processor, cause the platform to, after receiving the request from the application:
determine a request type of the request;
based on the request type, determine that the request is to be fulfilled by a card management system of the plurality of card management systems;
identify a tenant associated with the request;
based on the identified tenant, lookup the mapping between the application and the linked card management system; and
transform data of the request into a format required by the linked card management system;
wherein providing the data associated with the request to the linked card management system comprises providing the transformed data to the linked card management system.

3. The system of claim 1, wherein the application is a web application or a mobile application provided by a financial institution.

4. The system of claim 1,
further comprising a plurality of applications communicatively coupled to the platform;
wherein a first application of the plurality of applications is associated with a first financial institution and a second application of the plurality of applications is associated with a second financial institution;
wherein the mapping data includes a first mapping between the first application and a first card management system of the plurality of card management systems;
wherein the mapping data includes a second mapping between the second application and a second card management system of the plurality of card management systems;
wherein the first application and the second application are developed at least in part by a common application provider.

5. The system of claim 1, wherein the instructions, when executed by the processor, further cause the platform to:
receive a response from the linked card management system; and
route the response to the application.

6. The system of claim 1,
wherein the platform comprises a transformation service storing a plurality of transformations;
wherein a transformation of the plurality of transformations defines a conversion of the data associated with the request into data required for communicating with the linked card management system; and
wherein the transformation service includes a user interface for defining transformations of the plurality of transformations.

7. The system of claim 1, wherein the instructions, when executed, further cause the platform to, in response to receiving the request, perform a service, wherein the service is one or more of an identity service, a key management service, a digital card service, a financial instant issuance service, an EMV data preparation service, or a notification service.

8. The system of claim 1, wherein the instructions, when executed, further cause the platform to, in response to receiving the request, perform a service using a hardware security module.

9. The system of claim 1, wherein the instructions, when executed, further cause the platform to:
receive a request to update the mapping data; and
update the mapping data, wherein updating the mapping data comprises changing the mapping between the application and the linked card management system to be a mapping between the application and an updated linked card management system, the updated linked card management system being different from the linked card management system.

10. The system of claim 9,
wherein updating the mapping data does not include altering the API; and
wherein updating the mapping data does not result in a change to code of the application.

11. The system of claim 1,
wherein the system further comprises a plurality of card activation systems communicatively coupled to the platform; and
wherein the mapping data includes data linking tenants and the plurality of card activation systems.

12. The system of claim 1, wherein the platform comprises a cloud platform.

13. A computing system including a processor and memory storing instructions that, when executed by the processor, provide a cloud platform for facilitating digital financial services, the cloud platform comprising:
an interface communicatively connecting the cloud platform to an application associated with a tenant of the cloud platform, the application providing a financial service to a user;
a plurality of integrations coupling the cloud platform to each of a plurality of card management systems;
a database storing mapping data, the mapping data including a mapping between the tenant and a linked card management system, the linked card management system being from among the plurality of card management systems;
wherein the cloud platform is configured to:
expose a standardized application programming interface (API) to the application;
receive, via the standardized API, a request for execution by a card management system; and
based on the mapping between the application and the linked card management system, provide data associated with the request to the linked card management system.

14. The computing system of claim 13, wherein the computing system includes a plurality of computing devices, and wherein the cloud platform comprises a hybrid cloud platform.

15. The computing system of claim 13, wherein the instructions, when executed, further cause the platform to:
receive a request to update the mapping data for the tenant, the request to update the mapping data for the tenant including an identifier of a new card management system; and
change the mapping for the tenant from the linked card management system to the new card management system.

16. The computing system of claim 13,
wherein the application is provided from a financial institution to a customer as part of providing financial services; and
wherein the tenant is the financial institution.

17. The computing system of claim 13, wherein the instructions, when executed by the processor, further cause the computing system to:
log activity data of the computing platform; and
provide the activity data to an analytics system.

18. The computing system of claim 13, wherein the instructions, when executed by the processor, further cause the computing system to expose a plurality of APIs, the plurality of APIs including a card APIs and authentication APIs.

19. The computing system of claim 13, wherein the request is a request to activate a card.

20. A method for integrating digital financial services, the method comprising:
receiving, at an application programming interface (API) exposed by a platform, a request for a digital financial service from an application;
identify, using mapping data from a database of mapping data, a card management system linked to a tenant of the application, the identified card management system belonging to a plurality of card management systems coupled with the platform;
based on the identified card management system, determining a transformation for converting data to be received by the identified card management system;
by applying the transformation, converting data associated with the request to data formatted to be received by the identified card management system; and
providing the converted data to the identified card management system.
